(19) United States
(12) Patent Application Publication
(10) Pub. No.: US 2003/0141177 A1
(43) Pub. Date: Jul. 31, 2003

(54) Process for re-purfying highly enriched [H2180]

(76) Inventor: John W. Countz, Wichita, KS (US)

Correspondence Address: EDWARD L. BROWN, JR, Suite 1100, 125 North Market, Wichita, KS, 67202, US

(21) Appl. No.: 10/356,311

(22) Filed: Jan. 30, 2003

Related U.S. Application Data
(60) Provisional application No. 60/354,057, filed on Jan. 30, 2002.

(51) Int. Cl. B01D 3/10

(52) U.S. Cl. 203/11; 203/49; 203/91; 203/DIG. 7; 202/175; 202/205; 202/237; 202/265; 202/269

(57) ABSTRACT

A process for re-purifying highly enriched [H2180] for the reclamation and re-purification of highly enriched [H2180] after it has been used in the synthesis of [18F] by means of cyclotron particle bombardment, used in the synthesis of radiopharmacuticals such as [18F-FDG] or other radioactive labeled compounds for use in Positron Emission Tomography, commonly referred to as a P.E.T. Scan in the medical community, and render the re-purification product as clinical grade and suitable for re-introduction into that self-same [18F] production process for which it was previously used. The inventive device includes an evaporation flask, a condensation flask, a distillation adapter with a vacuum takeoff, a heating/magnetic stirring plate, a Teflon magnetic stir bar, a vacuum source, an inert gas source, a labyrinth filter and two glass secondarys.

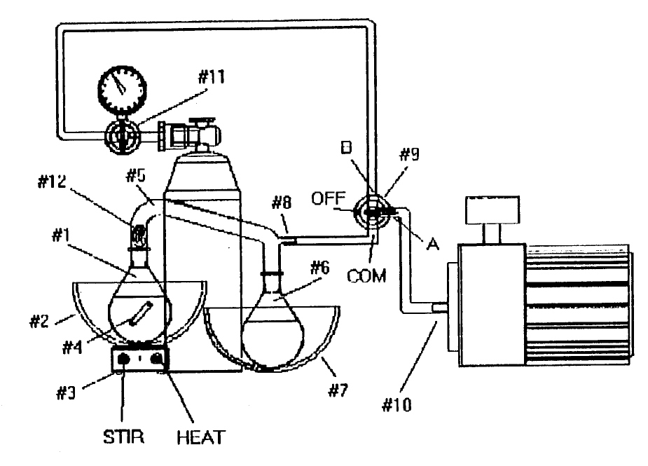

### DESCRIPTION OF THE PREFERRED EMBODIMENT

Turning now descriptively to the drawing which illustrates a process for re-purifying highly enriched [H218O]. The process comprises of evaporation flask 1, a condensation flask 6, a distillation adapter 5 with a vacuum takeoff 8, a heating/magnetic stirring plate 3, a Teflon magnetic stir bar 4, a vacuum source 10, an inert gas source 11, and two glass secondarys 2 and 7. Glass flasks 1 and 6 are plastic coated with a spherical bottom half and a conical top which slopes inward to form a cylindrical hollow neck at the top with a common tapered ground glass sealing surface. The vacuum source 10 is a standard motor driven vane style vacuum pump. A glass distillation adapter tube 5 has matching neck diameters of the evaporation and condensation flasks 1 and 6 with ground glass, tapered fittings. A temperature controlled warming plate 3 includes a spinning magnetic surface, which is used to induce movement of a magnetic stirring bar 4 which is a magnet enclosed in Teflon having a cylindrical bar shape with spherical ends. Glass dewars 2 and 7 are capable of containing the lower half of either the evaporation or condensation flasks 1 and 6. A product commonly used in chemistry as a filtration/trap media 12 such as inert glass wool is located in the neck of flask 1.

The Evaporation Flask 1 is a glass flask, plastic coated with a spherical bottom half and a conical top which slopes inward to form a cylindrical hollow neck at the top with a common tapered ground glass sealing surface. The evaporation flask 1 could be an internally inert surfaced container having a vapor/gas port located above the liquid fill level which would accommodate an internal or external fluid agitation or stirring device 4 and would allow for temperature and atmosphere pressure control of an encapsulated liquid. The shape of the evaporation flask 1 used for illustration herein is not limited to that described and may be of any shape and or relative size.

The Vacuum Source 10 is a common rotary vane style, electric vacuum pump that, through displacement, causes suction, thereby lowering the atmospheric pressure at its inlet to a valve 9 below ambient atmospheric pressure. The vacuum source 10 may be any device, which effects the reduction of ambient atmospheric pressure. Other means may include but are not limited to; lobe style pumps, helical screw pumps, piston pumps, diaphragm pumps, vortex devices, cyclonic devices and venturi devices.

The Condensation Flask 6 is a glass flask, plastic coated with a spherical bottom half and a conical top which slopes inward to form a cylindrical hollow neck at the top with a common tapered ground glass sealing surface. A condensation flask could be any internally inert surfaced container or contrived tubing arrangement having a port located above the liquid fill level which would accommodate internal condensation and or the collection of condensing fluids/vapors within itself during controlled temperature and atmospheric pressure conditions. The shape of the condensation flask 6 used for illustration herein is not limited to that described and may be of any shape and or relative size.

The Distillation Adapter tube 5 acts as a gas/vapor/liquid transfer corridor between the evaporation and condensation flasks 1 and 6. There is a vacuum takeoff nipple 8, which allows for the evacuation of vapors and gasses from the inside of the corridor and attached flask. It is located above the liquid fill line and optimally sloped downward from the evaporation flasks to the condensation flask. A distillation adapter tube 5 may be any internally inert tube forming a gas tight connection and gas/vapor/liquid corridor between the evaporation flask and the condensation flask for the purposes of a controlled atmosphere distillation conveyance. The vacuum nipple 8 may be located on the distillation adapter itself as shown or on the flasks 1 or 6 so long as it is above the liquid fill levels of the flask.

The Heating/Magnetic Stir Plate 3 is a temperature controlled electric warming plate with a spinning magnetic coupler which is used to induce movement of a magnetic stirring bar 4 and or act as a thermal control source to warm the liquid and or gasses inside the evaporation flask. The heating/magnet stir plate 3 may also be separate and distinct units, i.e. one for heating and one for stirring. Heating may be any thermal source effectively controlling the internal or spatial temperature of the liquid and or gas inside the evaporation flask given the application of sufficient levels of vacuum or negative atmospheric pressures inside the flasks. The control of ambient room temperatures may also be considered a heating source. Stirring refers to any agitation or excitation of the liquid molecules inside the evaporation flask 1. Stirring methods may include but are not limited to; mechanically or magnetically coupled devices, sonic or ultrasonic wave propagation or media coupled devices and laser spotting which causes small heat columns of molecular agitated fluid movement which in turn may cause thermal column turbulences.

Magnetic stir bar 4 is a magnet enclosed in TEFLON having cylindrical bar shape with spherical ends which floats inside the liquid of the evaporation flask 1, and is caused to spin by method of magnetic coupling when placed inside the spinning magnetic field of the heating/magnetic stir plate 3. A TEFLON magnetic stir bar may be any magnetically coupled mechanism which would float, roll or tumble around on the bottom of the evaporation flask 1 when subjected to a mechanically or electrically spinning magnet field and thereby effecting turbulent agitation of the contaminated [H218O] liquid held within the evaporation flask 1.

The inert gas source 11 is optimally laboratory grade Argon, delivered under controlled pressure by a regulator. The inert gas source 11 may be described as any pressure regulated inert gas supply either from compressed cylinders or onsite production, that may be used to displace ambient or reduced pressure atmospheres from the flasks and or, distillation adapter during the distillation or as part of the preparation process.

The glass secondary 2 or 7 also referred to as a common dewar dish or bowl is of sufficient inner diameter and height to encompass the liquid fill levels inside the evaporation and condensation flasks 1 and 6. A glass secondary is used in this application simply as a container to hold a thermal transfer medium and may be of any appropriate composition or could be replaced by any means of direct or indirect coupling or conduction aiding in the maintenance of a difference in temperature between the evaporation and condensation flasks, given that the condensation flask is always held at a lower temperature than that of the evaporation flask for the duration of the transfer of the [H218O] distillate.

The labyrinth trap 12 is an inert glass wool product commonly used in chemistry as a particulate filtration/trap media and provides a coalescent labyrinth, which traps by surface adherence, and incidental contact, certain types of contaminates present in gasses and vapors. A labyrinth trap may be any water inert structure which provides a coalescent effect and has multiple contact surfaces placed one in front of another in such fashion as to effect directional changes, turbulences or helical behavior in a flow of gas/vapor thereby causing that gas/vapor to be dragged across or along an increased surface area for the purposes of contact transference or deposition of contaminates onto that surface or surfaces. A commonly used, water inert, frit filter may be considered a labyrinth trap.

A vacuum hose is connected to the vacuum takeoff nipple 8 at the lower sloping end of the distillation adapter 5 and the other end of the vacuum hose is connected to the “common” port of the gas/vacuum valve 9. From the “A” port of valve 9 a vacuum hose is connected to the inlet of the vacuum source 10. From the “B” port of vacuum valve 9 a section of pressure rated tubing 13 or hose is connected and routed to the inert gas source 11 outlet. This is a total 3 connections to valve 9. The valve 9, when turned to the closed position, isolates all ports; when turned to the “A” port position connects the “common” port to the vacuum source via port “A” and when turned to the “B” port position the valve 9 provides a connection between the inert gas source 11 and the distillation assembly via the vacuum takeoff nipple 8 while isolating the “A” port. The vacuum source 10 and the heating/magnetic stir plate 3 are connected to a common 120 VAC duplex outlet. The glass secondary 2 containing the evaporation flask is filled to a level matching that of the flask fill level, with tepid water. The glass secondary 7 containing the condensation flask is filled to a matching level with a mixture of crushed dry ice and isopropyl alcohol. These fluids are for effecting either positive or negative thermal transfer during the process and could therefore be considered devices and or connection mediums. During certain phases of the purification process, the magnetic stir bar 4 inside the evaporation flask is suspended in the liquid [H218O] and is induced to spin by the spinning magnetic field of the heating/magnetic stir plate 3.

### OPERATION

The evaporation flask 1 condensation flask 6, and the distillation adapter 5 are rigorously cleaned, fully dried and flushed with an inert gas. The impure water is assessed for possible radioactivity and appropriate shielding is implemented to ensure safety for any persons involved with this process. The evaporation flask 1 which is inert gas filled is then loaded with the impure water and stoppered. After securing the evaporation flask 1 to prevent spillage, a glass secondary container 2 and heating/magnetic stir plate 3 is placed beneath the evaporation flask 1 and adjusted so the bottom of the evaporation flask 1 makes contact with bottom inside radius of the glass secondary 2 and the bottom outside surface of the glass secondary 2 is placed coincident, and concentric upon the functional top surface of the heating/magnetic stir plate 3. The glass secondary 2 must be of sufficient height as to house a water bath, which equals or exceeds the height of impure [H218O] inside the evaporation flask 1. The labyrinth trap 12 is inserted into the main corridor tube of the distillation adapter tube 5 at the higher sloped end and affixed accordingly so as not to allow slippage. The distillation adapter tube 5 and condensation flask 6 are then connected to the evaporation flask 1 in a gas tight fashion to achieve a “sealed distillation assembly”. The condensation flask 6 is placed in a glass secondary 7 plus a liquid/dry ice pellet chilling mixture and be of sufficient depth to house approximately 75% of its height. The pressure on the inert gas source is adjusted to approximately 1 psig. The valve 9 is turned to the “A” port position and vacuum source 10 is started so that there now exists a direct gas/vapor passage from the sealed distillation assembly through the vacuum takeoff nipple 8, through the “common” port connection valve 9 and through that valve via the “A” port to the inlet of the vacuum source 10. This is done so as not to cause a vacuum shock within the system. Magnetic stirring is then turned on and the system is left open to the vacuum source 10 for a time period conducive to sweeping out or removing trace impurities that may boil over under these conditions. The glass secondary 2 beneath the evaporation flask 1 is filled with ambient temperature water to a minimum height of the liquid level inside the evaporation flask 1 and sufficient heat is applied to remove any other impurities, with boiling points below that of [H218O] as achieved by characterization of the impure mixture and subsequent calculation which determine the appropriate heat/vacuum parameters for this phase of the operation. After achieving removal of lower boiling impurities, the system is changed to a static vacuum environment by adjusting the valve 9 to the center (off) position. Heat is then increased to the water bath, to optimize the transfer process. Special care must be taken not to exceed the vacuum/heat parameters conducive to the efficient transfer process. Special care must be taken not to exceed the vacuum/heat parameters conducive to the efficient transfer of [H218O], i.e. if the heat is too high for the level of the static vacuum inside the sealed distillation assembly the risk of undesirable liquid boil over or liquid/vapor sweep is very high. The condensation flask 6 is now chilled, by filling the glass secondary 7 with isopropyl alcohol and dry ice pellets. The transfer of [H2180] is allowed to occur under static vacuum until only [H218O] droplets are observed on the evaporation flask 1 walls. At this time the magnetic stirring is turned off and the system is intermittently opened to the vacuum source 10 by rotating the valve 9 back and forth between the “A” port and closed position, until no [H218O] can be observed in the evaporation flask 1. The gas/vacuum valve 9 must now be in the closed position, returning the sealed distillation assembly to a static vacuum state. The heat is turned off and the chilling bath contained in the glass secondary 7 is removed from beneath the condensation flask 6. The sealed distillation assembly is equilibrated to near ambient pressure with inert gas by slowly rotating valve 9 to the “B” port position so that inert gas may flow from the inert gas source entering the sealed distillation assembly. The valve 9 is then turned to the closed position. The condensation flask 6 is disconnected from the distillation adapter 5, taking care not to displace the argon covering cloud, and is immediately stoppered. The solid frozen mass in the condensation flask 6 is then thawed by immersion of the lower half of the condensation flask 6 in tepid water until a free floating mass of [H218O] ice is achieved within the condensation flask 6. The condensation flask 6 is then removed from the water and its contents are allowed to completely equilibrate to room temperature. The purified [H218O] may then be transferred from the condensation flask 6 into borosilicate glass crimp vials or other suitable storage containers, under an inert gas bath.

Any residues present in the evaporation flask should be surveyed for radioactivity, rinsed from the flask and stored in an appropriate fashion.

In place of the three positions, three-way valve 9 could be two separate open and close valves, one between the gas source 11 and adapter tube 5, and the other between the vacuum source 10 and adapter tube 5.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A sealed distillation system for purifying highly enriched [H218O] water comprising the components of:
an evaporation vessel containing the impure [H2180];
a condensation vessel;
a distillation adapter tube for connecting the evaporator vessel with a condensation vessel;
a heating source close coupled to the evaporation vessel;
a stirring mechanism to agitate the [H218O] positioned inside the evaporation vessel;
an inert gas source;
a vacuum source;
valve means positioned between the vacuum source and the adapter tube and the inert gas source and the adapter tube;
two secondary vessels for containing thermal fluids, one containing the evaporation vessel for heating, and the other containing the condensation vessel for cooling.

2. A sealed distillation system for purifying highly enriched [H218O] as set forth in claim 1 including a labyrinth trap positioned in the adapter tube.

3. A sealed distillation system for purifying highly enriched [H218O] as set forth in claim 1, wherein the adapter tube is sloped downward toward the condensation vessel and a labyrinth trap is positioned at the inlet end of the adapter tube.

4. A sealed distillation system as set forth in claim 1 wherein the labyrinth trap is glass wool, the evaporation and condensation vessels are spherical flasks with conical tops forming into cylindrical necks, the adapter tube connects to the necks of both vessels in air tight relation and the adapter tube includes at least one nipple which connects to the vacuum source and the inert gas source.

5. A sealed distillation system as set forth in claim 1 wherein the two secondary vessels are sized to contain a level of thermal fluid exceeding the height of the [H218O] in either vessel.

6. A sealed distillation system for purifying highly enriched [H218O] as set forth in claim 1 wherein the valve means is a 3-way 3-position valve positioned between the vacuum source, the inert gas source, and the adapter tube.

7. A sealed distillation system for purifying highly enriched [H218O] water comprising the components of:
an evaporation vessel containing the impure [H218O];
a condensation vessel;
a distillation adapter tube for connecting the evaporator vessel with a condensation vessel;
a heating source and magnetic stirring plate positioned under the evaporation vessel;
a magnetic stir bar positioned in the evaporation vessel;
an inert gas source connected to the distillation system;
a vacuum source connected to the distillation system;
a first valve positioned between the vacuum source and the distillation system;
a second valve positioned between the inert gas source and the distillation system;
two secondary vessels for containing thermal fluids, one containing the evaporation vessel for heating, and the other containing the condensation vessel for cooling.

8. A process for re-purifying highly enriched [H218O] water comprising the steps of:
a flush and fill all parts of a sealed distillation system with an inert gas;
placing an impure [H218O] in an evaporation vessel of the distillation system thereby displacing the inert gas;
apply a vacuum to the distillation system, which includes an evaporation vessel, condensation vessel, and a connecting tube therebetween;
apply heat and stir the impure [H218O] to a boiling point below that of the [H218O] to drive off organic impurities that are withdrawn through the vacuum source;
close the vacuum source to the system while maintaining a static vacuum in the system;
increase the heat and stir the evaporation vessel, which is under static vacuum to boil the impure [H218O] and chill the condensation vessel until the enriched water is substantially distilled.

9. A process for re-purifying highly enriched [H218O] water as set forth in claim 8 with the added step of intermittently opening and closing the distillation system to re-establish the vacuum source while distilling the impure [H218O].
